(19) United States
(12) Patent Application Publication
(10) Pub. No.: US 2026/0078731 A1
(43) Pub. Date: Mar. 19, 2026

(54) LAYER FOR INCREASING DAMPING ON WIND TURBINE BLADES

(71) Applicant: Gulf Wind Technology, LLC, Avondale, LA (US)

(72) Inventor: Murray Fisher, Morgantown, NC (US)

(73) Assignee: Gulf Wind Technology, LLC, Avondale, LA (US)

(21) Appl. No.: 19/332,774

(22) Filed: Sep. 18, 2025

Related U.S. Application Data
(60) Provisional application No. 63/696,127, filed on Sep. 18, 2024.

(51) Int. Cl. F03B 3/12; B32B 5/02; B32B 5/26

(52) U.S. Cl. CPC F03B 3/121; B32B 5/022; B32B 5/024; B32B 5/277; B32B 2250/05; B32B 2250/20; B32B 2262/065; B32B 2262/101; B32B 2262/106; B32B 2307/56; B32B 2603/00; F05B 2230/23; F05B 2280/6003

(57) ABSTRACT

A system and method for manufacturing a hybrid composite laminate system. The method includes positioning a plurality of non-natural fiber layers comprising at least one of: glass fibers and carbon fibers, preparing at least one natural fiber layer, and positioning the at least one natural fiber layer adjacent to, and in contact with at least one of the plurality of non-natural fiber layers. The method also includes increasing a first structural damping coefficient of the hybrid composite laminate system to be more than a second structural damping coefficient of a reference composite laminate without the natural fiber layer.

### CROSS-REFERENCE TO RELATED APPLICATIONS

This non-provisional patent application claims priority to U.S. provisional Ser. No. 63/696,127 , filed on Sep. 18, 2024, titled “Layer for increasing damping on wind turbine blades”, the contents of which are incorporated herein by reference in their entirety and should be considered part of this specification.

### BACKGROUND

Wind power is considered one of the cleanest, most environmentally friendly energy sources presently available, and wind turbines have gained increased attention in this regard. As the demand for wind energy continues to grow, there is an increasing emphasis on improving the efficiency of wind energy conversion systems. Wind turbine blades play a crucial role in capturing and converting wind energy into electrical power. Conventional designs, however, are often constrained by the trade-offs between aerodynamic efficiency and structural integrity.

Specifically, traditional wind turbine blades face a number of challenges associated with aerodynamic drag, noise generation, fatigue and inadequate damping or under-damping, which can limit their overall efficiency. In addition, these blades may be slow in their response to severe and unpredictable gust loads causing structural stress and increased fatigue degradation. There remains a need to optimize aerodynamic performance and damping while protecting and reducing structural stress on wind turbine blades.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter.

No attempt is made to show structural details in more detail than can be necessary for a fundamental understanding of the disclosed subject matter and various ways in which it can be practiced.

FIG. 1 shows an illustrative cross-sectional view of an example hybrid composite laminate system that includes constrained natural fiber layers, in accordance with an embodiment of this disclosure.

FIG. 2 shows an illustrative cross-sectional view of an example hybrid composite laminate system that includes constrained natural fiber layers, in accordance with an embodiment of this disclosure.

FIG. 3 shows illustrative cross-sectional views of two example hybrid composite laminate systems that include constrained natural fiber layers, in accordance with an embodiment of this disclosure.

FIG. 4 shows illustrative cross-sectional views of two example hybrid composite laminate systems that include constrained natural fiber layers, in accordance with an embodiment of this disclosure.

FIG. 5 shows illustrative cross-sectional views of two example hybrid composite laminate systems that include unconstrained natural fiber layers, in accordance with an embodiment of this disclosure.

FIG. 6 shows illustrative cross-sectional views of two example hybrid composite laminate systems that include unconstrained natural fiber layers, in accordance with an embodiment of this disclosure.

FIG. 7 shows illustrative cross-sectional views of two example hybrid composite laminate systems that include unconstrained natural fiber layers, in accordance with an embodiment of this disclosure.

FIG. 8 shows an illustrative cross-sectional view of an example hybrid composite laminate system that includes unconstrained natural fiber layers, in accordance with an embodiment of this disclosure.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

In an aspect of the disclosed subject matter, a hybrid composite laminate system is disclosed. The hybrid composite laminate system includes several traditional fiber materials (also denoted as non-natural fiber layers) comprising at least one of: glass fibers and carbon fibers, and at least one natural fiber layer positioned adjacent to, and in contact with at least one of the several non-natural fiber layers. The natural fiber material is a woven or non-woven sheet or fabric reinforcement made from a renewable fiber which is incorporated into a polymer matrix. In an instance, the natural fiber layer may include fibers including at least one of: Eryngium yuccifolium L, Industrial Hemp C. Sativa, Linum usitatissimum, Corchorus olitorius, and Pueraria montana var. Lobata. A first structural damping coefficient of the hybrid composite laminate system is higher than a second structural damping coefficient of a reference composite laminate without the natural fiber layer.

The natural fiber layer may be positioned internally within the hybrid composite laminate system between two or more non-natural fiber layers. This first configuration is denoted as a constrained configuration.

The natural fiber layer may be positioned externally to the hybrid composite laminate systems, adjacent to, and in contact with at least one surface of the non-natural fiber layers. This second configuration is denoted as an unconstrained configuration.

The natural fiber layer may include a non-woven mat configuration suitable for retrofitting to existing wind turbine blades. The retrofit layer may include any combination of the several fiber layers described later in this description.

The non-natural fiber layers may include a combination of unidirectional fibers and biaxial or multidirectional fibers.

The hybrid composite laminate system may further include a core material layer positioned between the natural fiber layers and the non-natural fiber layers. The core material may include at least one of: balsa, foam, and metallic materials.

The natural fiber layers may include several layers arranged by mass or area relative to the non-natural fiber layers.

The natural fiber layer may be positioned asymmetrically within the hybrid composite laminate system.

In an aspect of the disclosed subject matter, a method is disclosed for manufacturing a hybrid composite laminate system. The method includes positioning several non-natural fiber layers comprising at least one of: glass fibers and carbon fibers, preparing at least one natural fiber layer, and positioning the at least one natural fiber layer adjacent to, and in contact with at least one of the plurality of non-natural fiber layers. In an instance, the at least one natural fiber layer may include at least one of: Eryngium yuccifolium L, Industrial Hemp C. Sativa, and Pueraria montana var. Lobata. The method also includes increasing a first structural damping coefficient of the hybrid composite laminate system to be more than a second structural damping coefficient of a reference composite laminate without the natural fiber layer.

The method further includes positioning the natural fiber layer internally within the hybrid composite laminate system between two or more non-natural fiber layers. When positioned internally, the natural fiber layer may typically be constrained by the two or more non-natural fiber layers.

The method further includes positioning the natural fiber layer externally to the hybrid composite laminate systems, adjacent to, and in contact with at least one surface of the non-natural fiber layers. When positioned externally, the natural fiber layer may not be constrained by any non-natural fiber layer.

The natural fiber layer may include a non-woven mat configuration suitable for retrofitting to existing wind turbine blades. The retrofit layer may include any combination of the several fiber layers described later in this description. The non-natural fiber layers may include a combination of unidirectional fibers and biaxial or multidirectional fibers.

The method may further include positioning a core material layer between the natural fiber layers and the non-natural fiber layers. The core material may include at least one of: balsa, foam, and metallic materials.

In an aspect of the disclosed subject matter, a method is disclosed for retrofitting a structural component. The method may include identifying an application part of the structural component for retrofitting, applying a retrofittable hybrid composite laminate system to an interior or exterior surface of the application part of the structural component, and increasing a first structural damping coefficient of the structural component more than a second structural damping coefficient of a reference structural component without the natural fiber layer.

The applying a retrofittable hybrid composite laminate system may include positioning several non-natural fiber layers adjacent to, and in contact with the application part of the structural component. In an instance, the plurality of non-natural fiber layers may include at least one of: glass fibers and carbon fibers, preparing at least one natural fiber layer comprising at least one of: Eryngium yuccifolium L, Industrial Hemp C. Sativa, and Pueraria montana var. Lobata, and positioning the at least one natural fiber layer adjacent to, and in contact with at least one of the plurality of non-natural fiber layers.

The retrofittable hybrid composite laminate system may include a non-woven mat configuration suitable for retrofitting to the application part of the structural component.

The structural component may include a wind turbine blade of a wind turbine.

In an aspect of the disclosed subject matter, a wind turbine blade is disclosed such that the wind turbine blade includes the hybrid composite laminate system of any of the aspects of the subject matter disclosed above.

In an aspect of the disclosed subject matter, a wind turbine is disclosed such that the wind turbine includes one or more wind turbine blades. The one or more wind turbine blades includes the hybrid composite laminate system of any of the aspects of the subject matter disclosed above.

A hybrid composite laminate has been developed using natural fibers which, when used in a structural component (such as a hybrid composite laminate of this disclosure) such as a wind turbine blade or the like, may effectively increase the structural damping coefficient of the structural component by 10, 15, 20, 25% or more, as compared to a standard and reference structural component (such as a composite laminate) without natural fibers. This disclosure describes the technical details, technical benefits and economic demands of hybrid composite laminates from the wind energy sector, and an example processing method for an illustrative fiber source Eryngium yuccifolium L, Industrial Hemp C. Sativa and Pueraria montana var. Lobata.

As Wind Turbine rotor blade lengths increase, whether as part of the industry growth trends or due to specific designs for low wind sites such as the Southeast USA, the blades in the US and Global Onshore and Offshore wind industry tend to become heavier. Wind Turbine Blade length, Wind Turbine Blade mass and Wind Turbine Blade stiffness are commonly known to be directly related to the natural frequencies of the Wind Turbine blades. Further, wind turbine blade natural frequencies are known to be inversely related to the square of the Wind Turbine blade length and square root of Wind Turbine blade mass. Therefore, as Wind Turbine blade length increases, the fundamental frequencies of the Wind Turbine Blades are likely to continue to decrease (for a given stiffness), by as much as 20-30%, leading to potential crossings with operating rotor speeds.

Coupled with this trend is the low structural damping values of modern wind turbine blades (for example, 3% to 6% logarithmic damping values are generally reported in literature for two 5 MW and 15 MW reference wind turbines). These results indicate that larger blades may increasingly be subject to potential excitation from either excitation crossings or insufficient margin to driving frequencies, which, coupled with the lack of sufficient damping may lead to significant fatigue damages to the Wind Turbine blades and Wind Turbines.

Traditional engineering approaches to address the lack of sufficient Wind Turbine blade damping may include adding material to the Wind Turbine blades to increase mass or stiffness, sensing and controlling the wind turbine when potentially damaging vibrations occur, and early-stage research into passive and active damping control strategies. These approaches, while sometimes effective, may require introduction of parasitic mass or additional complex systems to the wind turbines that may not address the low structural damping directly, and may instead attempt to avoid or control unwanted vibration.

In this context, recent research studies describe how the wind turbine blade materials themselves may play a role in the overall damping of a wind turbine blade. The National Renewable Energy Laboratory (NREL) studied the use of thermoplastic resin for blade production, resulting in an increase in edgewise and flapwise damping from 0.21 % to 1.34% and 0.13 % to 0.70%, respectively.

This disclosure describes in detail the feasibility of applying retrofittable natural-fiber laminate layer, internally, on an existing wind turbine blade.

This disclosure describes a stepwise method for manufacturing a non-woven retrofittable natural fiber layer for enhancing structural damping in wind turbine blades that are already operational.

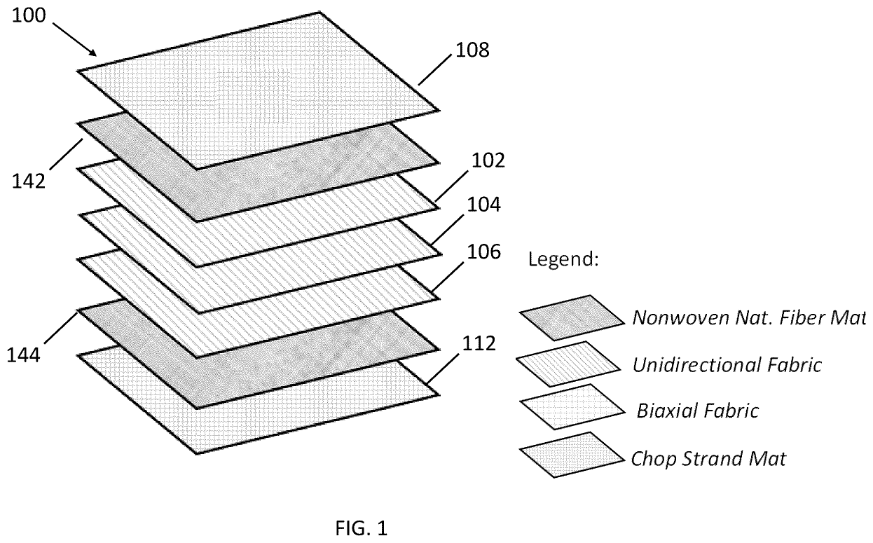

The configuration of the retrofit configuration or the integrated design version of the natural fiber laminate layers relative to the non-natural fiber layers is outlined in several constrained or unconstrained laminate example cases, as illustrated in FIGS. 1-8. The examples illustrated in FIGS. 1-8 are not exhaustive, nor do they indicate the prescribed ratio of natural to non-natural fiber, and serve to illustrate the range of configurations, but to not prescribe the only variants envisioned. The cases illustrated include the following non-limiting example cases:

FIG. 1 shows an illustrative cross-sectional view of a hybrid composite laminate system 100 that includes constrained natural fiber layers, in accordance with an embodiment of this disclosure. Referring to FIG. 1, the hybrid composite laminate system 100 may include several layers of non-natural fibers such as a combination of unidirectional fibers (glass or carbon fiber layers, including pultruded composite layers) 102, 104, 106 and so on. The hybrid composite laminate system 100 may further include a layer (or set of layers) 142, 144 and so on, of natural fiber placed internal to the layers of non-natural fibers 102, 104, 106 and so on. The layer (or set of layers) 142, 144 and so on, of natural fiber may be positioned adjacent to, and in contact with the layers of non-natural fibers 102, 104, 106 and so on. Further, the hybrid composite laminate system 100 may include one or more covering layers of non-natural fibers (chop strand mat, or biaxial or unidirectional fabric, as examples) 108, 112 and so on, to cover the hybrid composite laminate system 100.

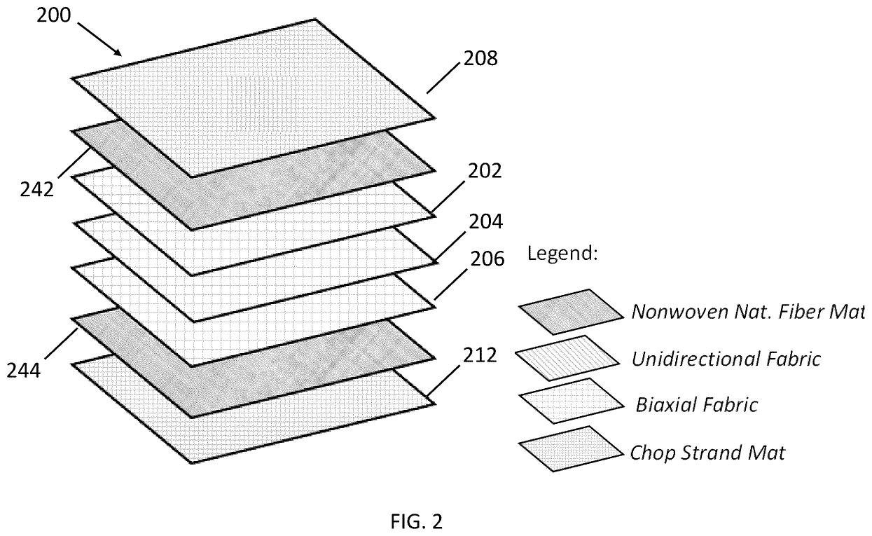

FIG. 2 shows an illustrative cross-sectional view of a hybrid composite laminate system 200 that includes constrained natural fiber layers, in accordance with an embodiment of this disclosure. Referring to FIG. 2, the hybrid composite laminate system 200 may include several layers of non-natural fibers such as a combination of biaxial or multidirectional fibers (glass or carbon fiber layers, including pultruded composite layers) 202, 204, 206 and so on. The hybrid composite laminate system 200 may further include a layer (or set of layers) 242, 244 and so on, of natural fiber placed internal to the layers of non-natural fibers 202, 204, 206 and so on. The layer (or set of layers) 242, 244 and so on, of natural fiber may be positioned adjacent to, and in contact with the layers of non-natural fibers 202, 204, 206 and so on. Further, the hybrid composite laminate system 200 may include one or more covering layers of non-natural fibers (chop strand mat, or biaxial or unidirectional fabric, as examples) 208, 212 and so on, to cover the hybrid composite laminate system 200.

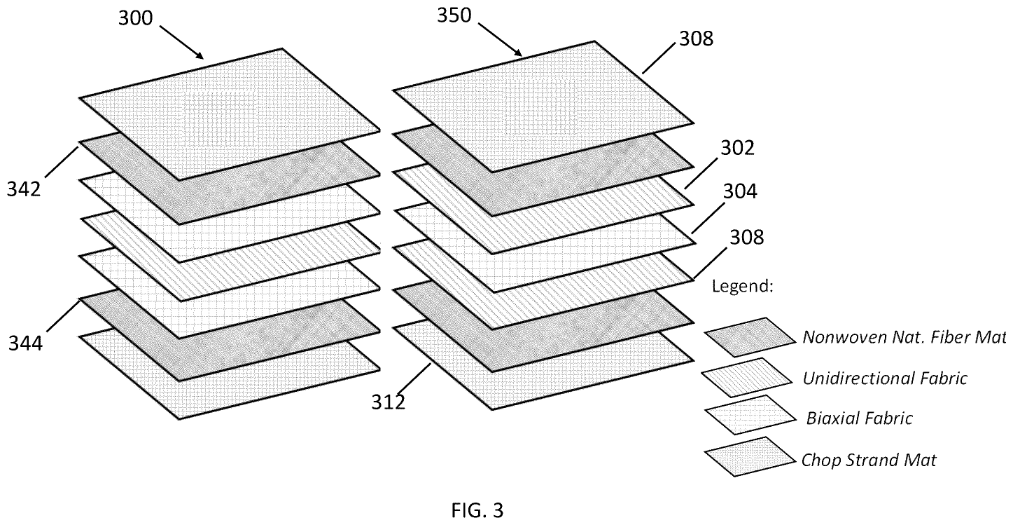

FIG. 3 shows illustrative cross-sectional views of an example hybrid composite laminate system 300, and an example hybrid composite laminate system 350 that include constrained natural fiber layers, in accordance with an embodiment of this disclosure. Referring to FIG. 3, the hybrid composite laminate systems 300 and 350 may include several layers of non-natural fibers such as a combination of uniaxial and biaxial or multidirectional fibers (glass or carbon fiber layers, including pultruded composite layers) 302, 304, 306 and so on. The hybrid composite laminate systems 300 and 350 may further include a layer (or set of layers) 342, 344 and so on, of natural fiber placed internal to the layers of non-natural fibers 302, 304, 306 and so on. The layer (or set of layers) 342, 344 and so on, of natural fiber may be positioned adjacent to, and in contact with the layers of non-natural fibers 302, 304, 306 and so on. Further, the hybrid composite laminate systems 300 and 350 may include one or more covering layers of non-natural fibers (chop strand mat, or biaxial or unidirectional fabric, as examples) 308, 312 and so on, to cover the hybrid composite laminate systems 300 and 350.

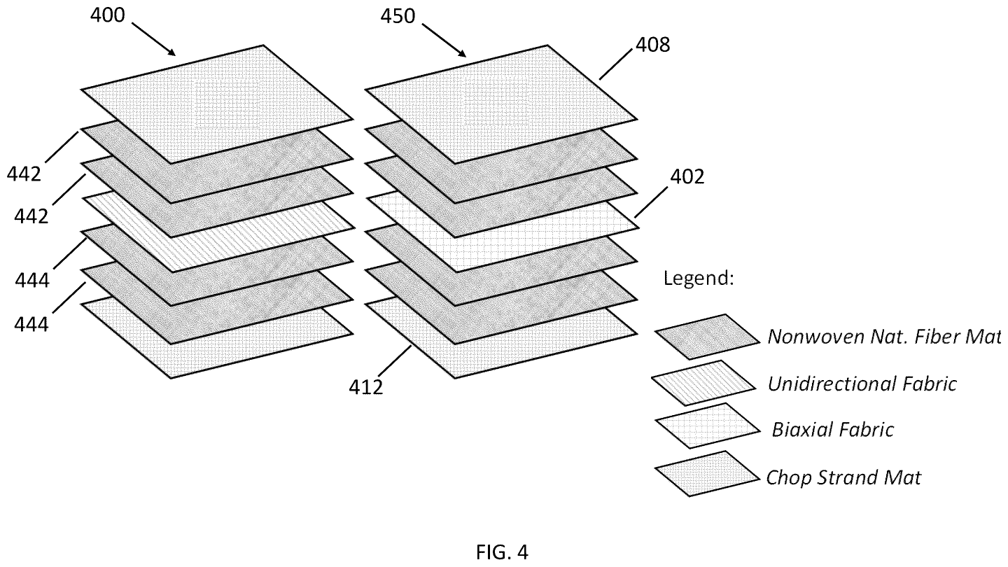

FIG. 4 shows illustrative cross-sectional views of an example hybrid composite laminate system 400, and an example hybrid composite laminate system 450 that include constrained natural fiber layers, in accordance with an embodiment of this disclosure. Referring to FIG. 4, the hybrid composite laminate systems 400 and 450 may include several layers of non-natural fibers such as a combination of uniaxial and biaxial or multidirectional fibers (glass or carbon fiber layers, including pultruded composite layers) 402. The hybrid composite laminate systems 400 and 450 may further include several layers, by mass or area, 442, 444 and so on, of natural fiber placed internal to the layers of non-natural fibers 402. The layer (or set of layers) 442, 444 and so on, of natural fiber may be positioned adjacent to, and in contact with the layers of non-natural fibers 402, 404, 406 and so on. Further, the hybrid composite laminate systems 400 and 450 may include one or more covering layers of non-natural fibers (chop strand mat, or biaxial or unidirectional fabric, as examples) 408, 412 and so on, to cover the hybrid composite laminate systems 400 and 450.

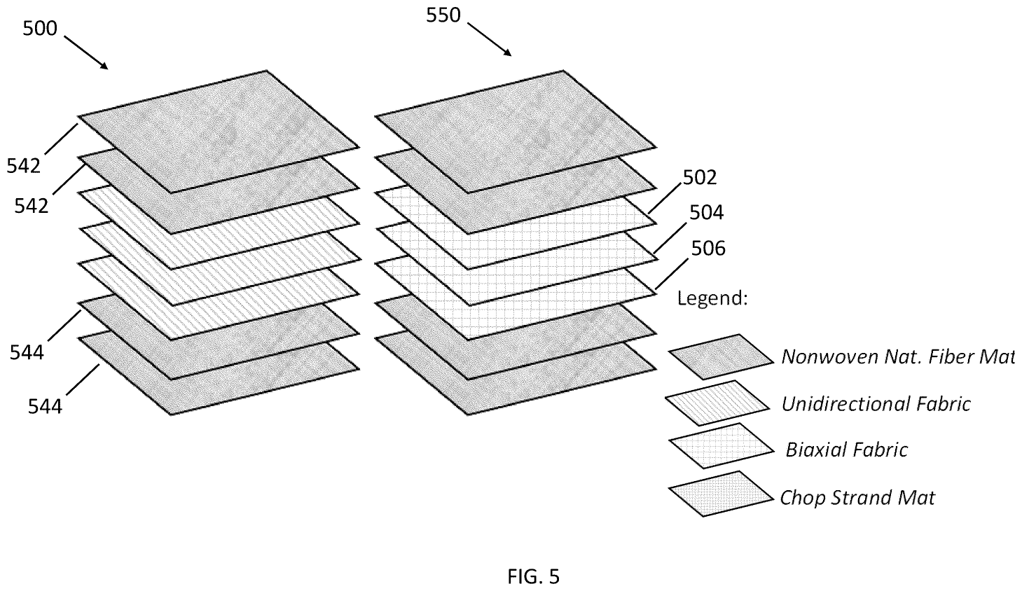

FIG. 5 shows illustrative cross-sectional views of an example hybrid composite laminate system 500, and an example hybrid composite laminate system 550 that include unconstrained natural fiber layers, in accordance with an embodiment of this disclosure. Referring to FIG. 5, the hybrid composite laminate systems 500 and 550 may include several layers of non-natural fibers such as a combination of uniaxial and biaxial or multidirectional fibers (glass or carbon fiber layers, including pultruded composite layers) 502, 504, 506, and so on. The hybrid composite laminate systems 500 and 550 may further include several layers, by mass or area, 542, 544 and so on, of natural fiber placed external to the layers of non-natural fibers 502, 504, 506, and so on. The layer (or set of layers) 542, 544 and so on, of natural fiber may be positioned adjacent to, and in contact with the layers of non-natural fibers 502, 504, 506 and so on.

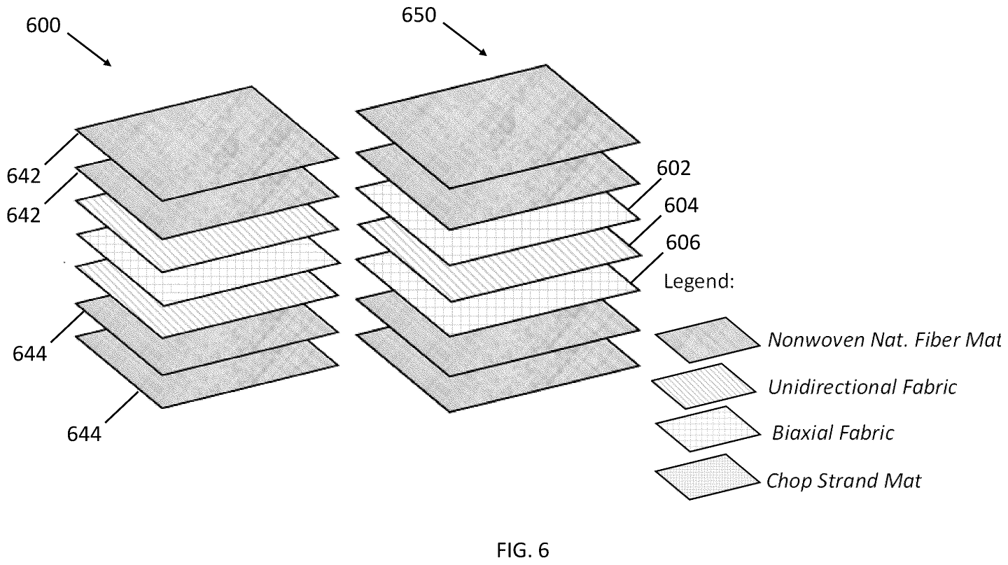

FIG. 6 shows illustrative cross-sectional views of an example hybrid composite laminate system 600, and an example hybrid composite laminate system 650 that include unconstrained natural fiber layers, in accordance with an embodiment of this disclosure.

Referring to FIG. 6, the hybrid composite laminate systems 600 and 650 may include several layers of non-natural fibers such as a combination of uniaxial and biaxial or multidirectional fibers (glass or carbon fiber layers, including pultruded composite layers) 602, 604, 606, and so on. The hybrid composite laminate systems 500 and 550 may further include several layers, by mass or area, 642, 644 and so on, of natural fiber placed external to the layers of non-natural fibers 602, 604, 606, and so on. The layer (or set of layers) 642, 644 and so on, of natural fiber may be positioned adjacent to, and in contact with the layers of non-natural fibers 602, 604, 606 and so on.

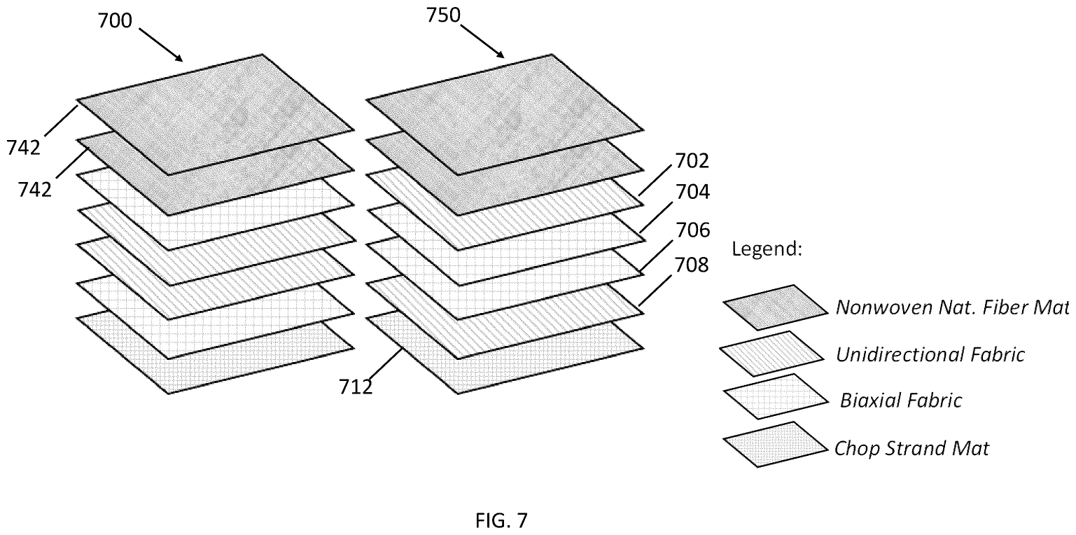

FIG. 7 shows illustrative cross-sectional views of an example hybrid composite laminate system 700, and an example hybrid composite laminate system 750 that include unconstrained natural fiber layers, in accordance with an embodiment of this disclosure.

Referring to FIG. 7, the hybrid composite laminate systems 700 and 750 may include several layers of non-natural fibers such as a combination of uniaxial and biaxial or multidirectional fibers (glass or carbon fiber layers, including pultruded composite layers) 702, 704, 706, and so on. The hybrid composite laminate systems 700 and 750 may further include several layers, by mass or area, 742, 744 and so on, of natural fiber placed unsymmetrically and external to the layers of non-natural fibers 702, 704, 706, and so on. The layer (or set of layers) 742, 744 and so on, of natural fiber may be positioned adjacent to, and in contact with the layers of non-natural fibers 702, 704, 706 and so on. Further, the hybrid composite laminate systems 700 and 750 may include one or more base layers of non-natural fibers (chop strand mat, or biaxial or unidirectional fabric, as examples) 712 and so on, to cover the base of the hybrid composite laminate systems 700 and 750.

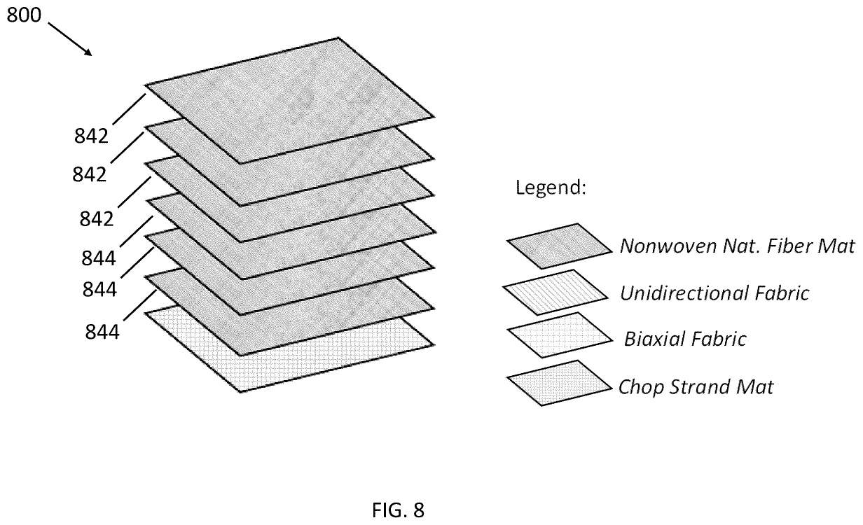

FIG. 8 shows illustrative cross-sectional view of an example hybrid composite laminate system 800 that includes unconstrained natural fiber layers, in accordance with an embodiment of this disclosure. Referring to FIG. 8, the hybrid composite laminate systems 800 may include several layers, by mass or area, 842, 844 and so on, of natural fiber placed unsymmetrically and external to the hybrid composite laminate system 800. Further, the hybrid composite laminate systems 800 may include one or more base layers of non-natural fibers (chop strand mat, or biaxial or unidirectional fabric, as examples) 802, to cover the base of the hybrid composite laminate system 800. The layer (or set of layers) 842, 844 and so on, of natural fiber may be positioned adjacent to, and in contact with the base layers of non-natural fibers (chop strand mat, or biaxial or unidirectional fabric, as examples) 802.

In an instance, any combination of: the layer (or set of layers) 142, 144 and so on, of natural fiber positioned adjacent to, and in contact with the layers of non-natural fibers 102, 104, 106 and so on, as in FIG. 1, the layer (or set of layers) 242, 244 and so on, of natural fiber positioned adjacent to, and in contact with the layers of non-natural fibers 202, 204, 206 and so on, as in FIG. 2, the layer (or set of layers) 342, 344 and so on, of natural fiber positioned adjacent to, and in contact with the layers of non-natural fibers 302, 304, 306 and so on, as in FIG. 3, the layer (or set of layers) 442, 444 and so on, of natural fiber positioned adjacent to, and in contact with the layers of non-natural fibers 402, 404, 406 and so on, as in FIG. 4, the layer (or set of layers) 542, 544 and so on, of natural fiber positioned adjacent to, and in contact with the layers of non-natural fibers 502, 504, 506 and so on, as in FIG. 5, the layer (or set of layers) 642, 644 and so on, of natural fiber positioned adjacent to, and in contact with the layers of non-natural fibers 602, 604, 606 and so on, as in FIG. 6, the layer (or set of layers) 742, 744 and so on, of natural fiber positioned adjacent to, and in contact with the layers of non-natural fibers 702, 704, 706 and so on, as in FIG. 7, the layer (or set of layers) 842, 844 and so on, of natural fiber positioned adjacent to, and in contact with the layers of non-natural fibers 802, 804, 806 and so on, as in FIG. 8, and so on, as described above, may be applied to one or more non-natural fiber laminates configured in a sandwich construction such that one or more core material layers may be included in a hybrid composite laminate (symmetrically or unsymmetrically) and may include balsa or foam or metallic materials, as non-limiting examples.

The disclosed hybrid composite laminate system and method offer significant structural and performance advantages over traditional damping approaches. Unlike conventional methods that add parasitic mass, complex sensing systems, or active control mechanisms, this innovation directly increases the structural damping coefficient of wind turbine blades by 10-25% through the integration of natural fiber layers (such as Eryngium yuccifolium L, Industrial Hemp C. Sativa, and Pueraria montana var. Lobata, as non-limiting examples) with glass and carbon fiber composites. The system and method address the critical under-damping problems prevailing in modern wind turbine blades, by targeting the root cause rather than attempting to control or avoid vibrations after they occur. This approach is particularly valuable for longer blades required in low wind speed regions where decreased natural frequencies and insufficient damping margins can lead to fatigue damage and structural stress from gust loads and frequency crossings.

Further, the hybrid composite laminate system and method provide both retrofit and manufacturing solutions that offer substantial economic advantages over traditional engineering approaches. The retrofittable non-woven mat configuration allows existing wind turbines to be upgraded post-construction, without requiring complete blade replacement. For new blade manufacturing, the natural fiber integration eliminates the need for additional complex systems, parasitic mass additions, or sophisticated control mechanisms that traditional approaches require.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is illustrative and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A hybrid composite laminate system comprising:
a plurality of non-natural fiber layers comprising at least one of: glass fibers and carbon fibers;
at least one natural fiber layer positioned adjacent to, and in contact with at least one of the plurality of non-natural fiber layers,
wherein a first structural damping coefficient of the hybrid composite laminate system is higher than a second structural damping coefficient of a reference composite laminate without the natural fiber layer.

2. The hybrid composite laminate system of claim 1, wherein the natural fiber layer is positioned internally within the hybrid composite laminate system between two or more non-natural fiber layers.

3. The hybrid composite laminate system of claim 1, wherein the natural fiber layer is positioned externally to the hybrid composite laminate systems, adjacent to, and in contact with at least one surface of the non-natural fiber layers.

4. The hybrid composite laminate system of claim 1, wherein the natural fiber layer comprises a non-woven mat configuration suitable for retrofitting to existing wind turbine blades.

5. The hybrid composite laminate system of claim 1, wherein the non-natural fiber layers comprise a combination of unidirectional fibers and biaxial or multidirectional fibers.

6. The hybrid composite laminate system of claim 1, further comprising a core material layer positioned between the natural fiber layers and the non-natural fiber layers, wherein the core material comprises at least one of: balsa, foam, and metallic materials.

7. The hybrid composite laminate system of claim 1, wherein the natural fiber layers comprise a plurality of layers arranged by mass or area relative to the non-natural fiber layers.

8. The hybrid composite laminate system of claim 1, wherein the natural fiber layer is positioned asymmetrically within the hybrid composite laminate system.

9. A method of manufacturing a hybrid composite laminate system, the method comprising:
positioning a plurality of non-natural fiber layers comprising at least one of: glass fibers and carbon fibers;
preparing at least one natural fiber layer;
positioning the at least one natural fiber layer adjacent to, and in contact with at least one of the plurality of non-natural fiber layers; and
increasing a first structural damping coefficient of the hybrid composite laminate system to be more than a second structural damping coefficient of a reference composite laminate without the natural fiber layer.

10. The method of claim 9 further comprising positioning the natural fiber layer internally within the hybrid composite laminate system between two or more non-natural fiber layers.

11. The method of claim 9 further comprising positioning the natural fiber layer externally to the hybrid composite laminate systems, adjacent to, and in contact with at least one surface of the non-natural fiber layers.

12. The method of claim 9, wherein the natural fiber layer comprises a non-woven mat configuration suitable for retrofitting to existing wind turbine blades.

13. The method of claim 9, wherein the non-natural fiber layers comprise a combination of unidirectional fibers and biaxial or multidirectional fibers.

14. The method of claim 9 further comprising positioning a core material layer between the natural fiber layers and the non-natural fiber layers, wherein the core material comprises at least one of: balsa, foam, and metallic materials.

15. A method of retrofitting a structural component, the method comprising:
identifying an application part of the structural component for retrofitting;
applying a retrofittable hybrid composite laminate system to an interior or exterior surface of the application part of the structural component; and
increasing a first structural damping coefficient of the structural component more than a second structural damping coefficient of a reference structural component without the natural fiber layer.

16. The method of claim 15, wherein the applying a retrofittable hybrid composite laminate system comprises:
positioning a plurality of non-natural fiber layers adjacent to, and in contact with the application part of the structural component, the plurality of non-natural fiber layers comprising at least one of: glass fibers and carbon fibers;
preparing at least one natural fiber layer; and
positioning the at least one natural fiber layer adjacent to, and in contact with at least one of the plurality of non-natural fiber layers.

17. The method of claim 15, wherein the retrofittable hybrid composite laminate system comprises a non-woven mat configuration suitable for retrofitting to the application part of the structural component.

18. The method of claim 15, wherein the structural component comprises a wind turbine blade of a wind turbine.

19. A wind turbine blade comprising the hybrid composite laminate system of claim 1.

20. A wind turbine comprising one or more turbine blades, the one or more wind turbine blades comprising the hybrid composite laminate system of claim 1.
